(19) United States
(12) Patent Application Publication
(10) Pub. No.: US 2022/0288479 A1
(43) Pub. Date: Sep. 15, 2022

(54) GOLF ASSISTING DEVICE AND METHOD WHICH CAN MEASURE PUTTING DISTANCE AND PUTTING DIRECTION

(71) Applicant: UNDERSTROKE CO., LTD., Seoul (KR)

(72) Inventor: Sunyoung WON, Seoul (KR)

(73) Assignee: UNDERSTROKE CO., LTD., Seoul (KR)

(21) Appl. No.: 17/627,022

(22) PCT Filed: Sep. 4, 2020
(86) PCT No.: PCT/KR2020/011956

§ 371 Date: Jan. 13, 2022

(30) Foreign Application Priority Data
Dec. 12, 2019 (KR) 10-2019-0165922

(51) Int. Cl. A63B 69/36; A63B 71/06; A63B 24/00

(52) U.S. Cl. CPC A63B 69/3676; A63B 71/0622; A63B 24/0021; A63B 2102/32

(57) ABSTRACT

A golf assisting device includes a distance measurement unit for measuring a distance from a user to the target point, a slope measurement unit for measuring a slope of a path from a main terminal to a target point, a putting information calculator for calculating putting information (putting distance and putting direction) necessary for the user from the measured distance and slope data, and an output unit for providing the calculated putting information to the user through a screen or voice.

### CROSS-REFERENCE TO PRIOR APPLICATIONS

This application is a National Stage Patent Application of PCT International Patent Application No. PCT/KR2020/011956 (filed on Sep. 4, 2020) under 35 U.S.C. § 371, which claims priority to Korean Patent Application No. 10-2019-0165922 (filed on Dec. 12, 2019), which are all hereby incorporated by reference in their entirety.

### BACKGROUND

The present invention relates to a line measurement technology of a golf green, in particular, relates to a device and method for automatically measuring a user's putting direction and putting distance by measuring and calculating the slope and height of the green to the hole cup based on the position of the golf ball.

With the development of personal mobile communication, auxiliary devices for users are known. Among them, there is a Korean Patent Application No. 10-2016-0146363, ‘device for measuring green slope for golf’. The prior art includes an angle sensor for detecting left/right and front/rear slope information of the main body by detecting a change in posture of the main body, a display unit for displaying and outputting left/right and front/back slope information detected from the angle sensor on a display screen, and a controller for controlling the obtained left/right and front/back slope information of the main body to be displayed on the display screen of the display unit. The prior art is a technology that a user may easily and accurately visually grasp the slope of a golf course green while carrying the device in a portable manner, and may be used in a short distance of about 5 m or less.

However, the prior art has the following problems.

1. Using a 2-axis gyro sensor: A gyro sensor is a sensor that measures the rotational angular velocity, and a 2-axis gyro sensor cannot accurately measure the slope in a state where the 2-axis gyro sensor is placed on the green without moving, that is, where the 2-axis gyro sensor is not moving.

2. Using a 2-axis gyro sensor: A gyro sensor is a sensor that measures the rotational angular velocity, and a 2-axis gyro sensor cannot accurately measure the slope in a state where the 2-axis gyro sensor is placed on the green without moving, that is, where the 2-axis gyro sensor is not moving.

3. The measurement result display is ambiguous: Because there is no way to measure the distance, only the height of the green when the terminal is placed is displayed (e.g., 90%). And there is no precise indication of the putting direction, just replacing the putting direction with a line.

4. Available only within 5 m: There is a contradiction that the putting distance and putting direction cannot be measured only by measuring the slope without measuring the distance. In the prior art, it is specified that the device may be used only within 5 m due to the contradiction. However, because the putting direction changes depending on the distance, the device cannot be accurately measured even at 1 m. In addition, there is a limitation in that the device can be applied only to almost flat lines as the device does not include a correction function at a point with severe curvature depending on the green condition.

5. Lack of practicality: For the above reasons, the practicality of the prior art is questioned not only for the game on the green, but also for practice in the driving range.

### SUMMARY

As described above, the present invention is completed by focusing on the point that the prior art does not give usefulness to the user as a golf assisting device. An object of the present invention is to provide a device and method capable of automatically calculating the final putting direction and putting distance by measuring the slope and distance of putting using a main terminal and an auxiliary terminal possessed by the user, and correcting the slope and distance of putting when necessary.

According to an aspect of the present invention for solving the above problems, a golf assisting device capable of measuring putting distance and putting direction may include a distance measuring unit for measuring the distance from a user to a target point, a slope measuring unit for measuring a slope of a path from a main terminal to the target point, a putting information calculator for calculating a putting distance and a putting direction required for the user from the measured distance and slope data; and an output unit for providing the calculated putting information to the user.

In addition, according to another feature of the present invention for solving the above problems, a golf assisting method may include measuring a distance from a user to a target point by measuring the distance using an augmented reality (AR) function, measuring a slope using the AR function to measure vertical and horizontal slopes of a path from the user's location to the target point, calculating a putting distance and a left and right putting direction to be finally putt by the user using the measured distance and the vertical slope, and generating and outputting display data for displaying the calculated putting distance and putting direction.

According to one embodiment of the golf assist device and method of the present invention, the main terminal includes an ultra-wideband (UWB) anchor for communication with an auxiliary terminal, the auxiliary terminal communicates with the UWB anchor of a main terminal to exchange distance data with the main terminal, and may include a UWB tag for measuring the distance to the UWB anchor, an impact sensor for detecting an impact of a ball stroked by a user, and a two-axis or more acceleration sensor for measuring the slope and height of the location of the auxiliary terminal. In this case, it is preferable that the main terminal is mobile communication carried by the user, and the auxiliary terminal is arbitrarily designated by the user or located at the hole cup point.

An idea of the present invention introduced above will become clearer through specific embodiments described later with drawings.

According to the present invention, a user can be provided with a putting direction and putting distance using his/her smartphone, and if necessary, the putting direction and putting distance can be corrected, allowing accurate play without the help of a caddy, greatly reducing the cost of helping a professional caddy.

In addition, according to the present invention, by providing more precise green information to amateur users, it will be possible to obtain the effect of improving putting ability and reducing the number of golf strokes.

Furthermore, according to the present invention, even professional users can use the golf assisting device in the practice round before the game to receive the overall putt information in advance, so that the professional users can improve their performance in a main game.

### BRIEF DESCRIPTION OF THE DRAWINGS

FIG. 1 is a block diagram of a main terminal 100 according to an embodiment of the present invention.

FIG. 2 illustrates a configuration of a distance measuring unit 110 and necessary peripheral components.

FIGS. 3A and 3B are exemplary views of a user interface (UI) of a main terminal 100.

FIG. 4 is an exemplary diagram of a UI for distance measurement using an augmented reality (AR) function.

FIG. 5 shows a configuration of a slope measuring unit 120 and necessary peripheral components.

FIGS. 6A and 6B are exemplary views of a user interface (UI) for measuring slope by an AR function.

FIG. 7 is an explanatory diagram of a method of measuring a slope using the main terminal 100.

FIG. 8 is a configuration diagram of the putting information calculator 130.

FIG. 9 is an exemplary diagram of a display UI 141 of the output unit 140.

FIG. 10 is a block diagram of the distance measuring unit 110 according to an embodiment to which a distance correction function is added.

FIGS. 11A to 11C are exemplary views of a method for correcting a distance.

FIG. 12 is a configuration diagram of a slope measuring unit 120 according to an embodiment to which a tilt correction function is added.

FIG. 13 is a block diagram of an embodiment in which an auxiliary terminal 200 is additionally included in addition to a main terminal 100.

FIG. 14 is a configuration diagram of an embodiment different from the embodiment of FIG. 13.

### DETAILED DESCRIPTION

Advantages and features of the present invention and methods of achieving them will become apparent with reference to the detailed description in conjunction with the accompanying drawings. However, the present invention is not limited to the embodiments disclosed below, but will be implemented in various different forms. This embodiment serves only to complete the disclosure of the present invention, and is provided to fully inform those of ordinary skill in the art to the scope of the invention, and the present invention is defined by the description of the claims. On the other hand, the terms used herein are for the purpose of describing the embodiment, not intended to limit the present invention. In this specification, the singular also includes the plural unless specifically stated otherwise in the phrase. As used herein, ‘comprise’ or ‘comprising’ does not exclude the presence or addition of one or more other components, steps, operations and/or elements other than the recited elements, steps, operations and/or elements.

Hereinafter, preferred embodiments of the present invention will be described in detail with reference to the accompanying drawings. In adding reference numerals to the components of each drawing, the same reference numerals are given to the same components even if the reference numerals are shown in different drawings. In addition, in describing the present invention, when detailed descriptions of related known structures or functions may obscure the gist of the present invention, the detailed description thereof will be omitted.

<Basic Configuration of the Invention>

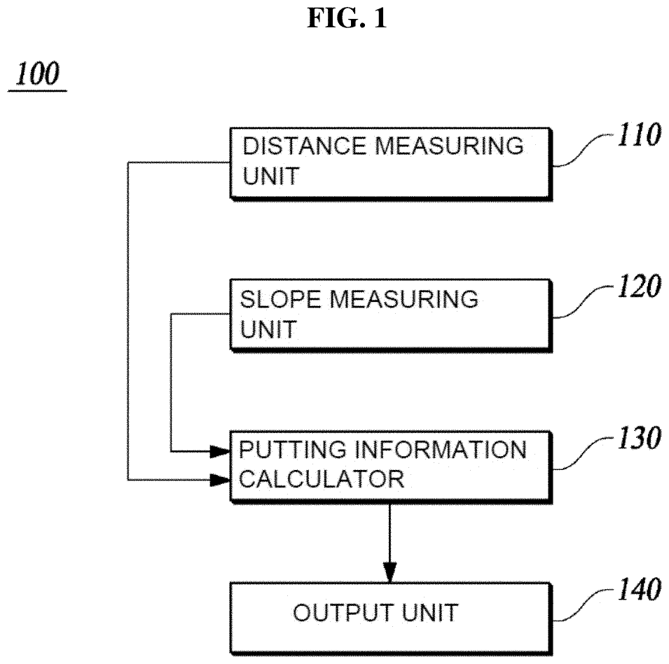

FIG. 1 is a basic configuration diagram of the present invention. The basic configuration shown in FIG. 1 may be implemented as a smart phone, a tablet, a PDA, or the like, or may be implemented as a dedicated terminal. Hereinafter, they will be referred to as ‘main terminals’. On the green or in the driving range, the user carries the main terminal and receives the putting information (distance and direction) for the target hole cup and point through the output unit of the main terminal through a screen or voice.

Referring to FIG. 1, the main terminal 100 includes a distance measuring unit 110 for measuring the distance from the main terminal 100 carried by the user to the target point (e.g., hole cup), a slope measuring unit 120 for measuring the slope of the path from the main terminal 100 to the target point, a putting information calculator 130 for calculating the putting information (putting distance and putting direction) required for the user from the measured distance and slope data, and an output unit 140 for providing the calculated putting information to the user in a screen or voice.

Each of the above components will be schematically described.

The distance measuring unit 110 may obtain and process the distance value (the distance from the user to the hole cup) directly input by the user as distance data, or directly measure the distance from the actual terrain of the green or driving range by using the augmented reality (AR) function and ultra-wideband (UWB) distance measuring technology.

The slope measuring unit 120 may measure the slope (left and right, and up and down slope) of the path from the user's position to the hole cup using an acceleration sensor (for example, an acceleration sensor of two or more axes), or may measure the slope in an AR method using an acceleration sensor (e.g., an acceleration sensor with two or more axes) and an AR application programming interface (API).

The putting information calculator 130 calculates putting information necessary for the user by using the measured (or input by the user) distance data and slope data. Here, in order to provide putting information to the user, the mapping of raw data output from the distance measuring unit 110 and the slope measuring unit 120 into golf terms is performed in parallel. The putting information includes, for example, an arrow indicating the actual putting direction, a putting distance finally calculated through the measurement distance and the calculation of the vertical slope value (e.g., xx meters), and a final putting direction calculated by calculating the left and right slope values (e.g., ‘3 cups on the right side’, ‘2 cups on the left side’, etc.)

The output unit 140 displays the calculated putting information in texts and pictures, and if necessary, the calculated putting information may be expressed by voice. The output unit 140 may be implemented as a screen display user interface (UI) of the main terminal 100.

<Detailed Configuration of the Invention>

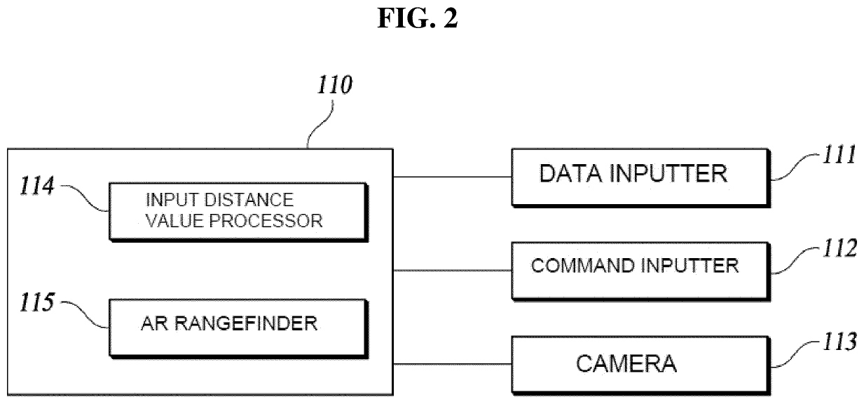

FIG. 2 shows a configuration of the distance measuring unit 110 and necessary peripheral components.

First, the necessary peripheral components are described. A data inputter 111 and a command inputter 112 are connected to the distance measuring unit 110. The distance data inputter 111 allows the user to directly input data such as distance values. The command inputter 112 inputs a user's command when necessary during a distance measurement task execution in the distance measuring unit 110. In addition, a camera 113 is connected to the distance measurement unit 110 for distance measurement by the AR function.

Next, the configuration of the distance measuring unit 110 is described. The distance measuring unit 110 includes an input distance value processor 114 and an AR rangefinder 115. The input distance value processor 114 receives and processes the distance value input from the distance data inputter 111. The AR rangefinder 115 measures distance by performing an AR function in conjunction with the camera 113, the AR API, and the acceleration sensor (two axes or more).

The input distance value processor 114 receives a distance value that is roughly counted as a walking length on the green as in the conventional case, distance value measured by a separate laser rangefinder, or distance value known through guide media (booklets, internet, etc.), which are directly input by the user through the distance inputter 111. In addition, the input distance value processor 114 performs necessary processing on the received distance values, outputs the processed distances as distance data, and transmits the distance data to the putting information calculator 130.

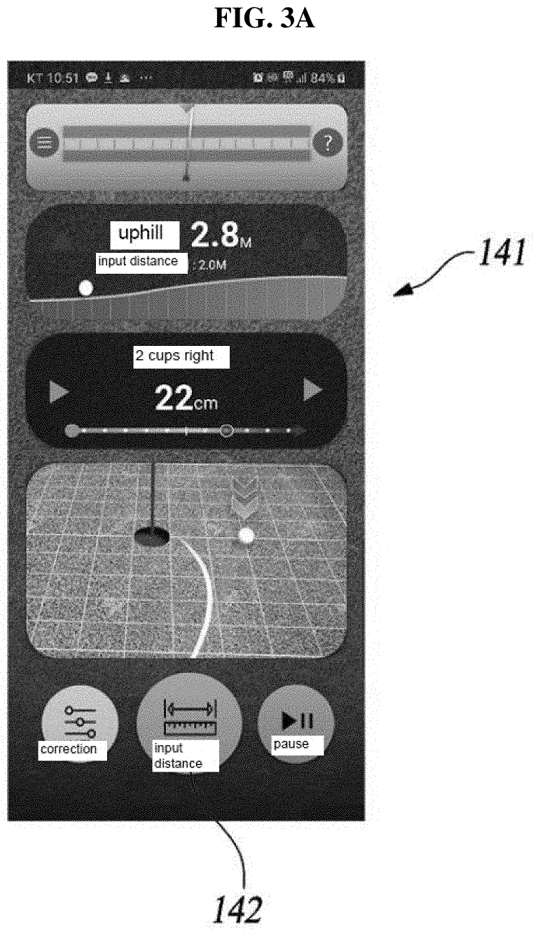

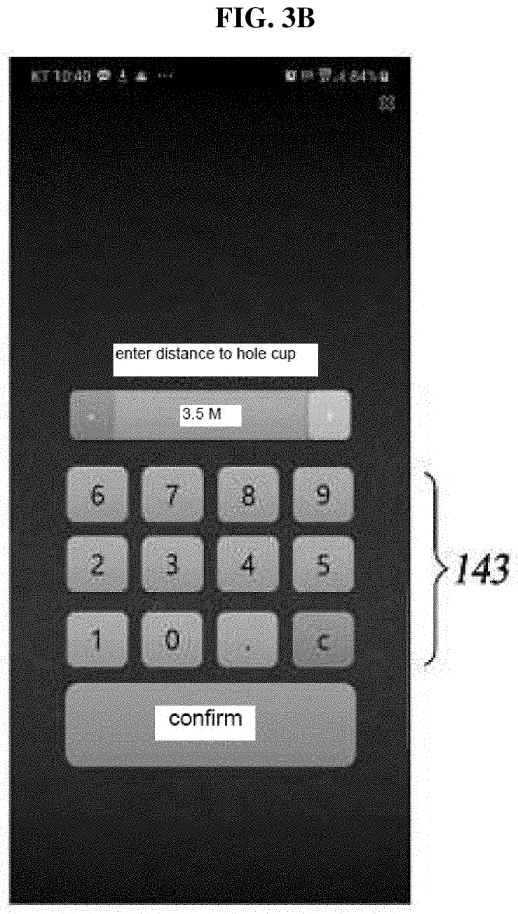

The distance data inputter 111 required in this case may be implemented as a keypad or a screen touch UI of the main terminal 100. Examples of the UI are shown in FIGS. 3A and 3B. FIG. 3A shows a UI 141 for inputting and outputting information so that a user may use the golf assisting device of the present invention. When the distance input button 142 is pressed in the UI shown in FIG. 3A, a distance value input screen as shown in FIG. 3B appears. On the screen shown in FIG. 3B, the user may input a distance value that he or she has measured by using the numeric keypad 143 or learned through another route (such as a laser rangefinder or guide book).

Referring back to FIG. 2, the AR rangefinder 115 uses the camera 113 to capture an image of an area to measure a distance. Then, the AR function is executed using the AR API and the two-axis or more acceleration sensor (not shown) to display the augmented reality view overlaid on the actual image. On the augmented reality screen, the user designates two points of the distance to be measured using the command inputter 112, that is, a hitting position (position of a ball) and a target position (position of a hole cup). The AR rangefinder 115 calculates and digitizes the actual distance between the two specified points from the actually captured image. The digitized distance data is transmitted to the putting information calculator 130.

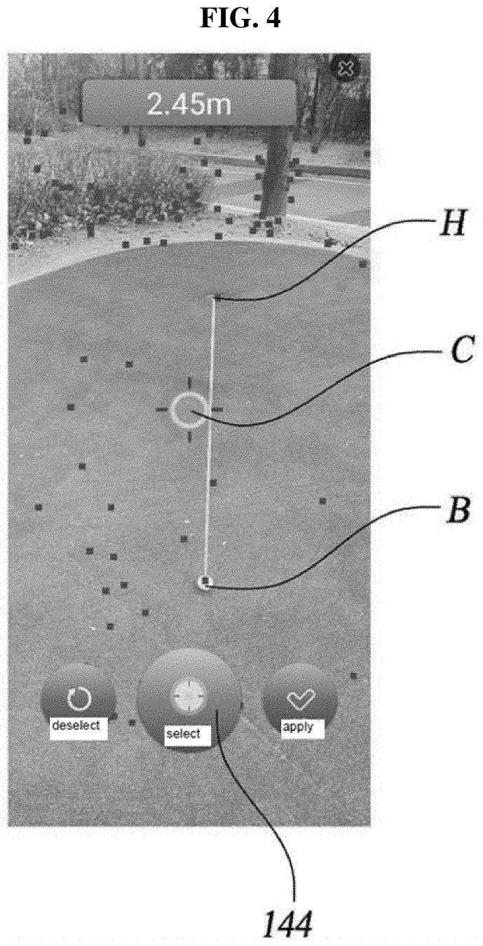

The command inputter 112 may also be implemented as a UI of the main terminal 100. An example of the UI is shown in FIG. 4. As shown in FIG. 4, the center target point C of the main terminal 100 is aligned with the hitting position (position of the ball) B, and the selection button 144 is pressed. Then, the target point C is aligned with the position H of the hole cup and the selection button 144 is pressed. When the values of the X, Y, and Z axes in the augmented reality corresponding to the two specified points are digitized and extracted, the distance between the two points B and H is calculated.

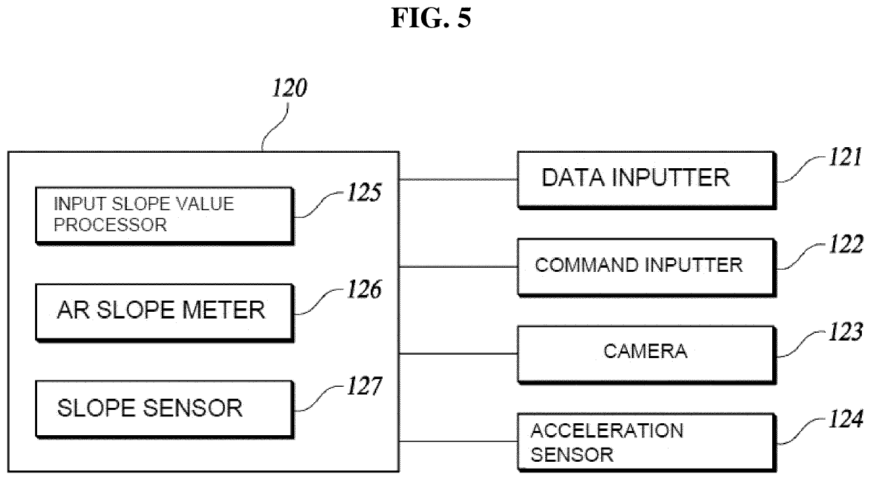

FIG. 5 shows the configuration of the slope measuring unit 120 and necessary peripheral components.

First, necessary peripheral components are described. A slope data inputter 121 and a command inputter 122 are connected to the slope measuring unit 120. The slope data inputter 121 allows a user to directly input data such as a slope value. The command inputter 122 allows the user to input the user's command when the user's command is required while the slope measurement task is executed by the slope measuring unit 120. In addition, a camera 123 is connected to the slope measurement unit 120 in order to measure the slope by the AR function, and an acceleration sensor 124 for detecting the slope of the terrain is connected. This acceleration sensor 124 has two or more axes.

Next, the configuration of the slope measuring unit 120 will be described. The slope measuring unit 120 includes an input slope value processor 125 and a slope sensor 127. The slope value input from the data inputter 121 is received and processed.

An AR slope meter 126 measures the slope in an AR method in conjunction with the camera 123. The slope sensor 127 is connected to the acceleration sensor 124 to detect and measure the slope.

The input slope value processor 125 receives a distance value that is roughly counted as a walking length on the green as in the conventional case, distance value measured by a separate laser rangefinder, or distance value known through guide media (booklets, internet, etc.), which are directly input by the user through the distance inputter 111. In addition, the input slope value processor 125 performs necessary processing on the received distance values, outputs the processed distances as distance data, and transmits the distance data to the putting information calculator 130.

The data inputter 121 used for this may be implemented with a UI similar to that shown in FIGS. 3A and 3B. In addition, it is possible to integrate the data inputter 111 for distance input and the data inputter 121 for slope input into one UI.

Referring back to FIG. 5, the AR slope meter 126 of the slope measuring unit 120 measures the slope degree (left and right, and up and down) of the golf green and the green contour (green curvature and irregular lines) using the AR function. That is, through the camera 123, the topographical features of the area to be measured slope are photographed, and the augmented reality view is displayed on the live-action image through the AR API and the AR function using the two-axis or more acceleration sensor. When the topographical features of the surrounding environment are scanned, the AR API may measure the slope degree and contour elevation from the user's location to the hall by analyzing the color, contrast, and illuminance of the live-action image in augmented reality. By collecting and analyzing the X, Y, and Z coordinates of the region of interest of the measured slope degree and contour elevation data, the slope degree value of the feature in augmented reality may be digitized and calculated. The digitized distance data is transmitted to the putting information calculator 130.

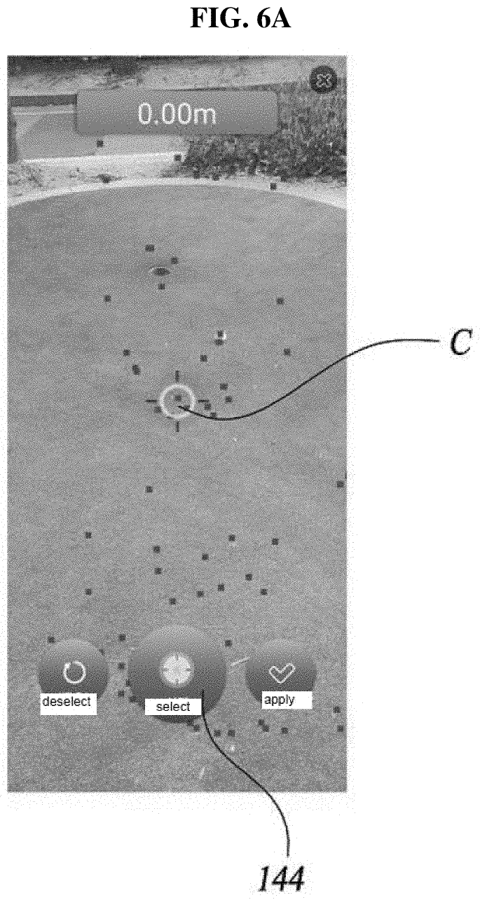

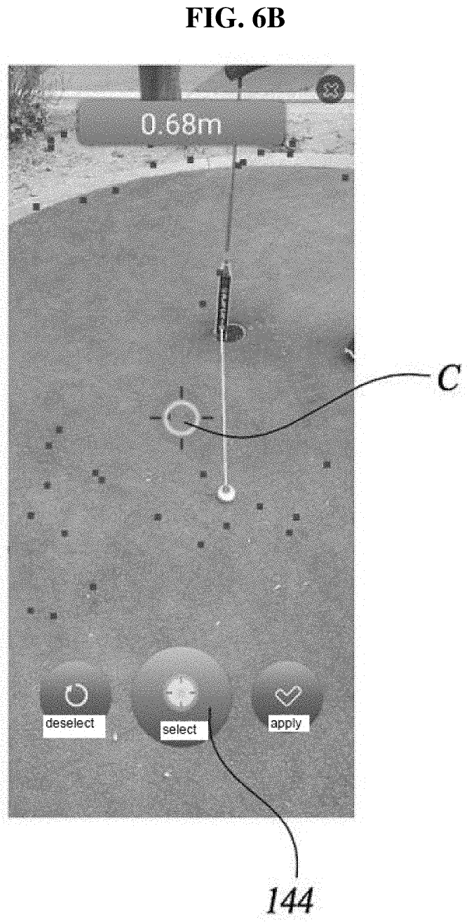

In this case, an example of a UI that may be used is shown in FIGS. 6A and 6B. The UI of FIGS. 6A and 6B is similar to that shown in FIG. 4. Slope data such as the contour elevation and curvature of the corresponding terrain is displayed as dots in augmented reality (AR) on the slopes, grooves, and bends on the live-action image. This slope data is input to the AR slope meter 126. Alternatively, according to another embodiment, when the user aligns the target point C and presses the selection button 144, the slope data of the corresponding location may be input to the AR slope meter 126 and reflected in calculating the slope data.

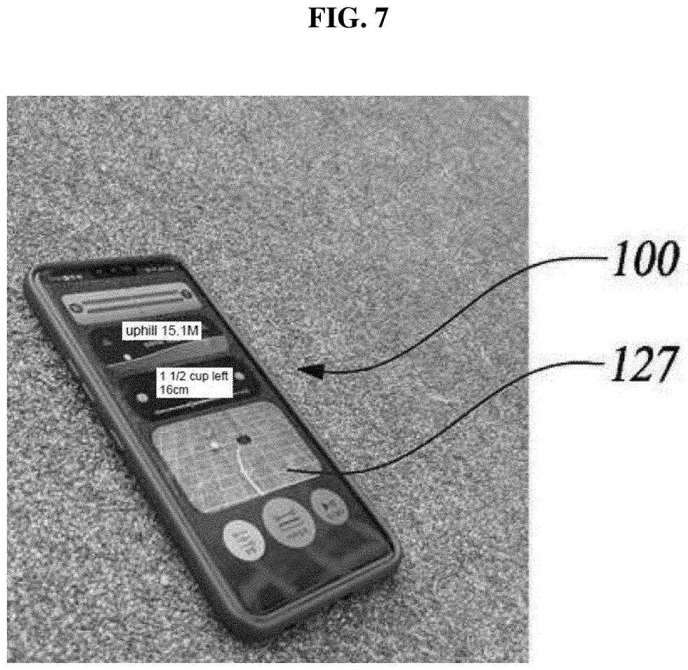

Referring back to FIG. 5, the slope sensor 127 of the slope measuring unit 120 measures the slope degree (left and right, and up and down) of the green using the acceleration sensor 124 of at least two axes. For example, when the main terminal 100 including the slope sensor 127 of the present invention is put down on a sloped terrain as shown in FIG. 7, the built-in two-axis or more acceleration sensor 124 operates to measure the left and right, and up and down slopes of the corresponding terrain.

The slope sensor 127 digitizes the measured value and transmits it to the putting information calculator 130. The transmitted data may be quantified as left and right (−10 to +10) and up and down (−10 to +10) values, and the putting information calculator 130 reflects the digitized data in the calculation of the putting distance and the left and right direction values through a specific normalized table and calculation formula.

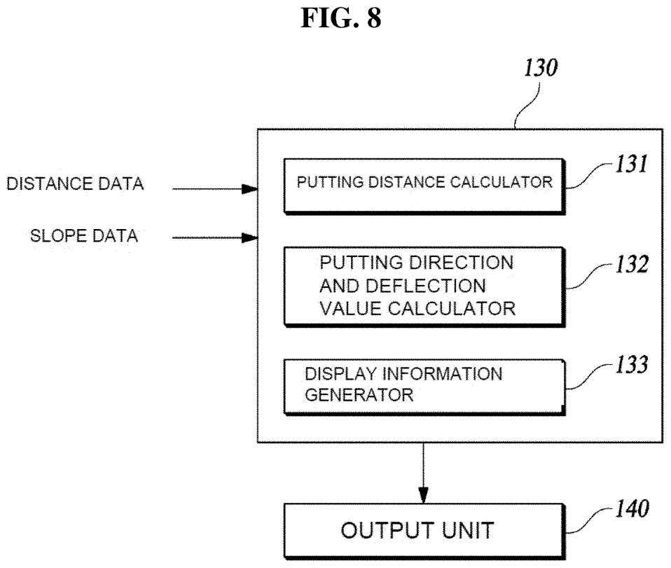

Finally, returning to FIG. 1, the putting information calculator 130 calculates putting information using the received calculation result, that is, digitized distance data and slope data, uses this information in a golf game and maps it into a golf term that the user may understand and provides it to the user. FIG. 8 is a block diagram of the putting information calculator 130. The putting information calculator 130 includes a putting distance calculator 131 for calculating the distance that the user should finally putt by using the distance data and the vertical slope degree value, a putting direction and deflection value calculator 132 for calculating a left and right direction value and a deflection value to be finally putt using the left and right slope degree values, and a display information generator 133 that generates display data for displaying the calculated putting distance and putting direction and sends it to the output unit 140. Here, the putting direction and deflection value calculator 132 may additionally calculate a putting distance, a direction value, and a deflection value depending on the green speed.

Assuming that the putting distance calculated by the putting distance calculator 131 of the putting information calculator 130, for example, the input or measured distance is 3 m, and the vertical slope value is downhill (i.e., a negative (−) value), the actual putting distance may be 2.8 m reflecting the downhill slope value. This actual putting distance may be calculated using a reference table or formula.

In addition, for the putting direction calculated by the putting direction and deflection value calculator 132, for example, assuming that the left and right slope values are positive (+) values to the right based on the hole cup (i.e., right uphill), the actual putting direction reflects this right slope value and calculates how much the putt should be deflected to the right rather than the actual hole cup. This actual putting direction and deflection distance may also be calculated using a reference table or formula. For example, the actual putting direction and deflection value of ‘2 cups on the right’ or ‘22 cm on the right’ is calculated so that the putting is biased to the right by about 2 cups from the actual hole cup. Here, the deflection value of the right 2 cups is the distance assuming there are 2 hole cups from the end of the hole cup to the right (typically 1 cup=about 10.8 cm).

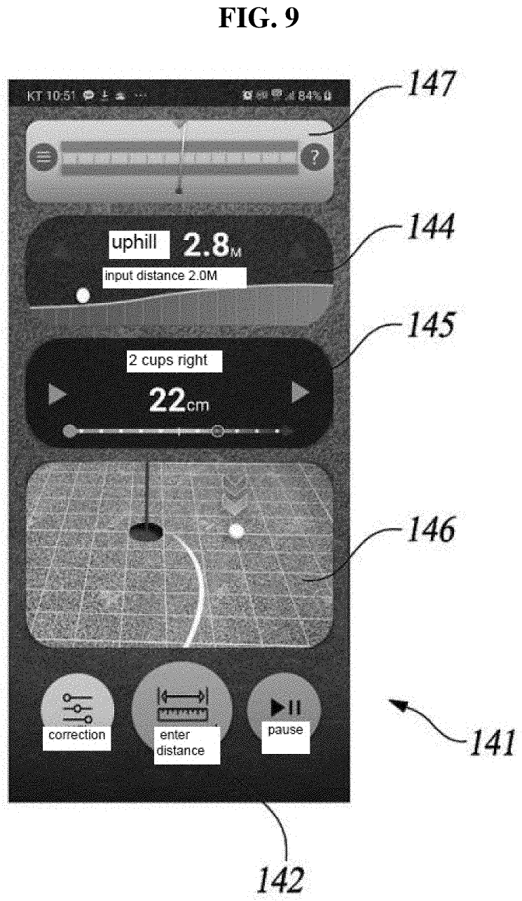

The display information generator 133 expresses the calculated putting distance and putting direction as visual information or auditory information so that the calculated putting distance and the putting direction may be easily understood, and provides visual information or auditory information to the output unit 140. An example of a display UI 141 of the output unit 140 is shown in FIG. 9 (the UI has already been described in FIG. 3A).

In FIG. 9, the display UI 141 of the output unit 140 includes a putting distance numerical indicator 144 for numerically displaying the putting distance calculated by reflecting the vertical slope value by the putting distance calculator 131, a putting direction numerical indicator 145 for displaying the putting direction and deflection value calculated by the putting direction and deflection value calculator 132 by reflecting the left and right slope values, as numerical values, a putting direction/ball trajectory graphic indicator 146 for reflecting the putting direction numerical value displayed on the putting direction numerical indicator 145 to graphically show the putting direction and the ball trajectory; and a putting direction graphic indicator 147 for graphically displaying (e.g., an arrow) the direction to be actually put the user's location to the target hole based on the putting distance and putting direction data.

When the user puts after determining the position to be put as displayed in the putting direction/ball trajectory graphic indicator 145 and confirming the actual direction to be struck displayed on the putting direction graphic indicator 147, the ball actually enters the hole cup by the up, down, left, and right slope of the green.

### <Another Embodiment>—Example with Data Correction Function Added

In addition to the basic configuration of the invention described above, an embodiment including a data correction function is proposed. The correction functions in this embodiment include distance correction and slope correction.

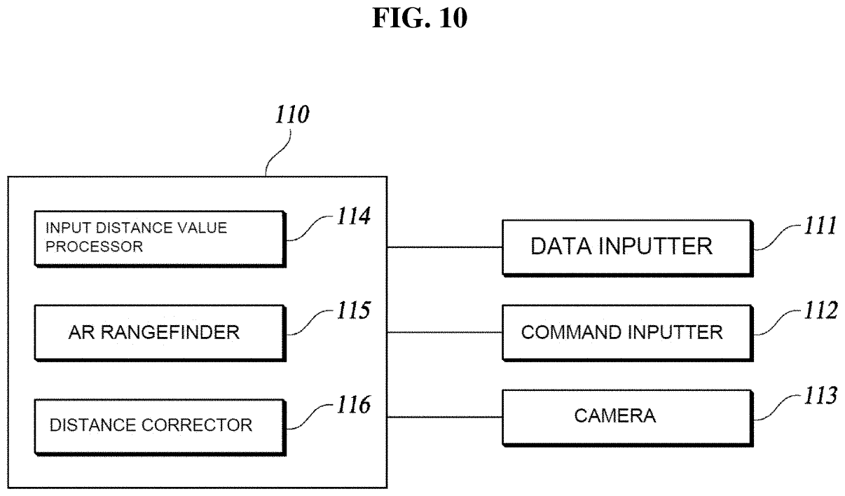

FIG. 10 is a block diagram of the distance measuring unit 110 according to this embodiment. Compared to the configuration of FIG. 2, a distance corrector 116 is added. In a case where the stroke line is not inclined regularly and there is a section in which the slope and height change severely, the actual distance and the slope are different, so that a more accurate result value may be calculated by performing correction through the distance corrector 116.

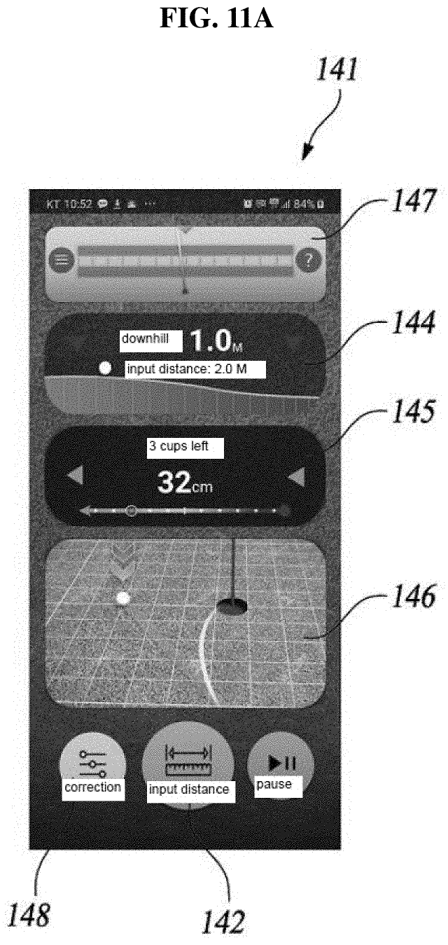

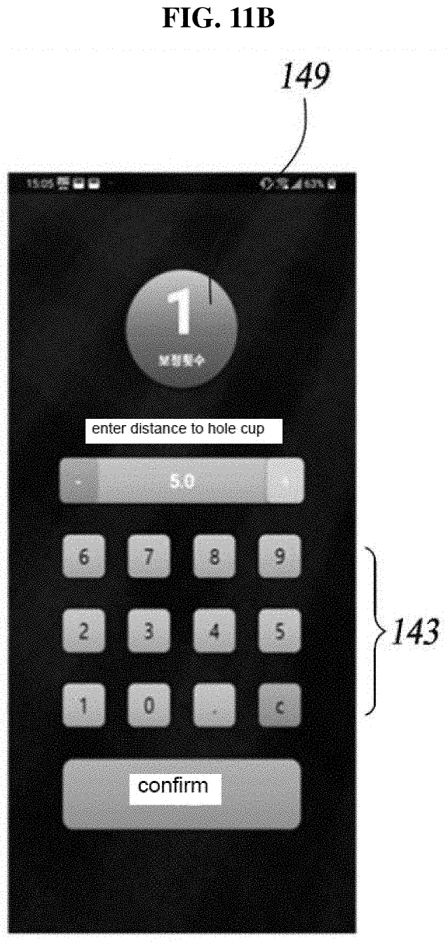

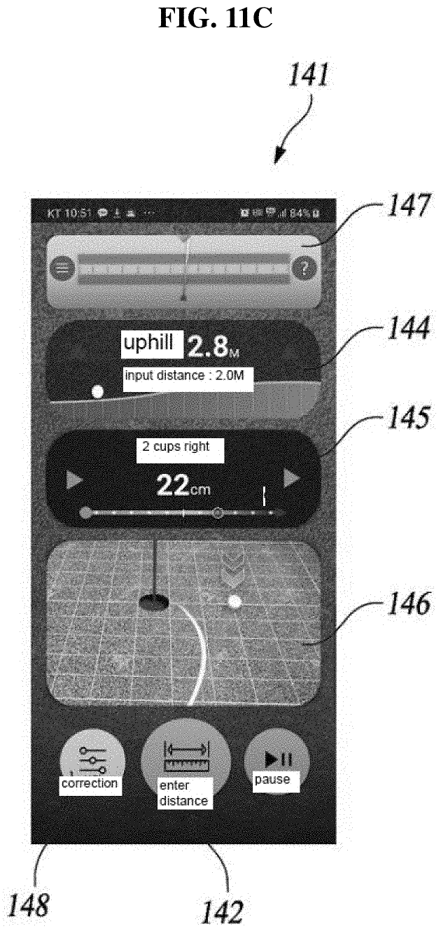

A user who recognizes that the distance of the stroke line measured primarily is different from the actual distance may cause the distance corrector 116 to operate through the command inputter 112. A correction selection means (148 in FIG. 11a) is added to the command inputter 112, so that the user selects a correction function through the correction selection means, and 1) manually inputting a new distance value (e.g., the distance from the point where the slope and height change to the hole cup), or of 2) the distance measuring unit 110 of the main terminal 100 performs a task of correcting the first measured distance.

The correction function is explained in detail through the UI. In FIG. 11A again showing the UI screen 141 shown in FIG. 9, the first calculated putting distance is displayed on the putting distance numerical indicator 144 as ‘downhill 1.0 m’ and the first calculated putting direction is displayed on the putting direction numerical indicator 145 as ‘left 3 cups 32 cm’.

In the case of the former (correction distance input by the user), when the correction button 148 at the lower portion of the UI screen 141 of FIG. 11A is pressed, a distance input screen as shown in FIG. 11B is displayed. This screen is similar to the manual distance input screen shown in FIG. 3B.

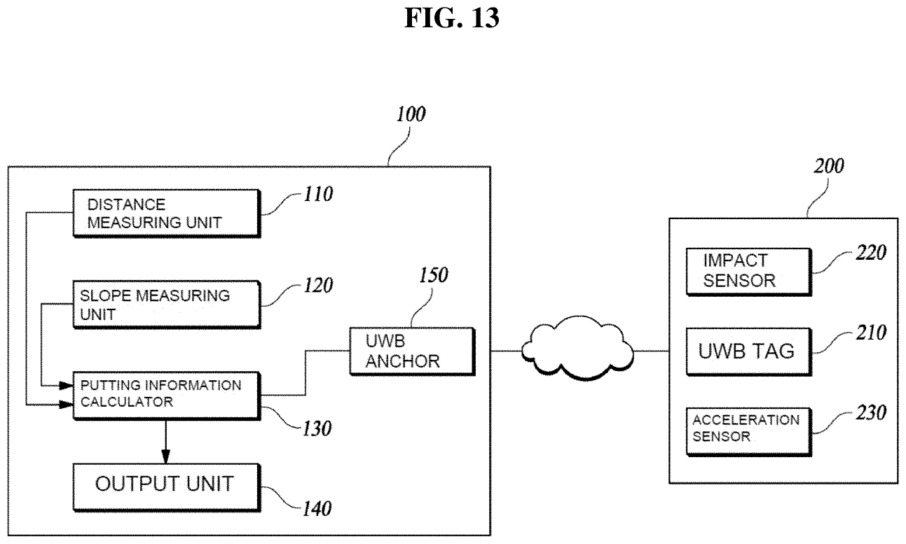

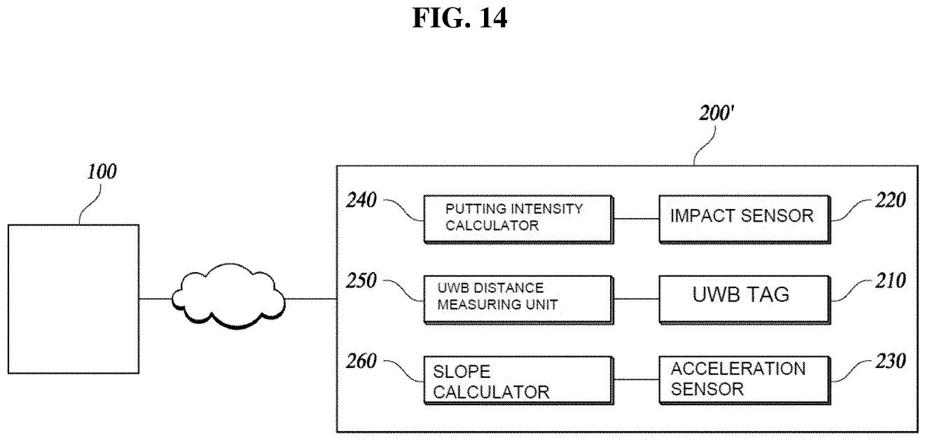

When a new distance value to be corrected is input using the keypad 143 of this screen, the distance corrector 116 of the distance measuring unit 110 measures the slope and height of the corresponding section to correct the first calculated distance. In the latter case (the distance measuring unit 110 of the main terminal 100 corrects the distance), as described above, the distance measuring unit 110 measures, calculates and corrects the distance again by the AR method (or by the UWB distance measurement of FIGS. 13 and 14 to be described later). During correction, the slope existing in the path of the putting distance is additionally measured and this slope degree value is additionally reflected. In this case, the slope measuring unit 120 shown in FIG. 5 also acts.

When the execution of this correction task is completed, as shown in FIG. 11C, information to be finally putt is displayed by calculating the first measured value and the corrected value. Referring to FIG. 11C, the information displayed on a putting distance numerical indicator 144, a putting direction numerical indicator 145, a putting direction/ball trajectory graphic indicator 146, and a putting direction graphic indicator 147 is corrected and displayed (i.e. 2.8 m uphill and 22 cm right 2 cups). As described above, the UI of FIG. 11A is an implementation example of the command inputter 112, and the UI of FIG. 11B is an implementation example of the data inputter 111.

It may be designed so that the correction may be performed as many times as necessary without limiting the number of corrections. (e.g., after measuring a distance of 20 meters, when 10 sections that require correction are identified, all 10 corrections are possible). The number of corrections may be displayed on the display UI so that the user may know. For example, it may be seen that the UI is configured so that a correction number indicator 149 is displayed in the upper portion of FIG. 11B.

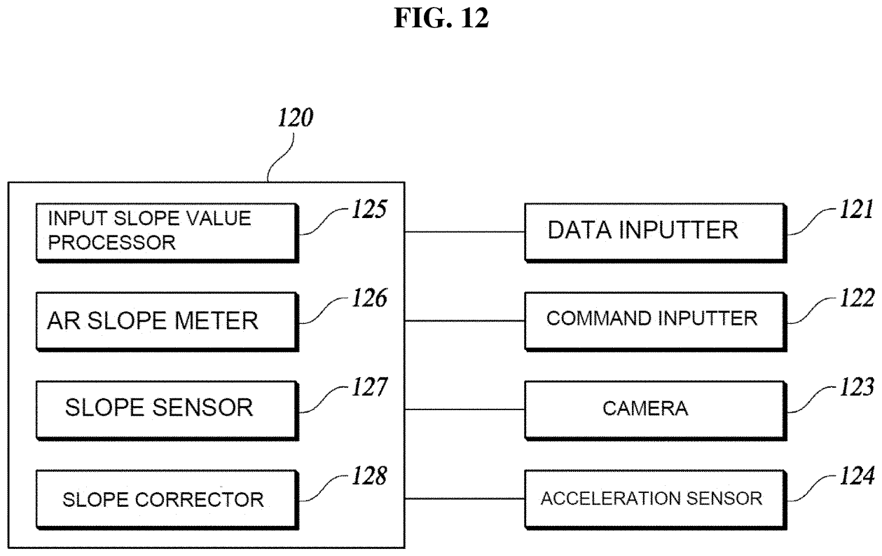

Meanwhile, FIG. 12 is a configuration diagram of the slope measuring unit 120 according to an embodiment to which a slope correction function is added. It may be seen that a slope corrector 128 is added when compared with the configuration of FIG. 5. Similar to the distance corrector 116 of FIG. 10, the operation of the slope corrector 128 may also be triggered by the user through the command inputter 122. In addition, after triggering the operation of the slope corrector 128 through the command inputter 122, a new slope value may be input through the data inputter 121, or the slope corrector 128 may correct itself to a new slope value.

The UI of the command inputter 122 and the data inputter 121 for the user to directly input a new slope value may be easily implemented by a person skilled in the art is similar to that shown in FIGS. 11A to 11C, so a description thereof is omitted.

Self-slope correction by the slope corrector 128 may be performed in conjunction with the AR slope meter 126 of FIG. 5. That is, after the first measurement of the slope, the AR function is used to recheck and correct the contour elevation of the green (green curves and irregular lines). First, the AR slope meter 126 predicts and draws the line in which the ball moves in the augmented reality based on the first measured value. In the drawn line, it analyzes and displays the section where the slope and elevation change through the terrain slope and contour elevation analysis function (refer to FIGS. 6A and 6B) through AR as described above. After measuring the slope and height through the AR slope meter 126 of the main terminal 100 in the displayed section, a correction value for the previously measured value is calculated, and finally, information to be put is displayed through the UI of FIG. 11C.

The slope measuring unit 120 also measures the slope again when the distance measuring unit 110 performs distance correction as described above and provides it to the distance measuring unit 110.

### <Another Embodiment>—an Embodiment in which an Auxiliary Terminal is Added

As described above, it is possible to assist the user with the main terminal 100 alone, but in order to further strengthen the auxiliary role of the user, an auxiliary terminal is additionally included to reinforce the function of the main terminal and promote user convenience.

FIG. 13 is a block diagram of this embodiment. An auxiliary terminal 200 for UWB communication with the main terminal 100 is added. The main terminal 100 may be implemented as a smartphone or a dedicated terminal carried by the user as described above, the auxiliary terminal 200 may be implemented as a circular or disk-shaped device embedded in a hole cup. In addition, the auxiliary terminal 200 may be implemented as a stick-type terminal in the form of a straight line.

For communication between the main terminal 100 and the auxiliary terminal 200, a UWB anchor 150 is included in the main terminal 100, and a UWB tag 210 is embedded in the auxiliary terminal 200. The auxiliary terminal 200 may be used in the driving range or on the green when practicing putting. The UWB anchor 150 of the main terminal 100 carried by the user serves as a golf ball and the UWB tag 210 of the auxiliary terminal 200 located at the hole cup point functions as a hole cup, so that the distance from the ball to the hole cup may be measured through mutual communication.

UWB wireless technology is a new wireless technology that is applied to communications and radar by using a very wide frequency band of several GHz or more in the baseband without using an RF carrier. The UWB wireless technology, by using a very low spectral power density that is identical to the noise of conventional wireless systems, is rapidly emerging as a new next-generation wireless technology because it may share and use frequencies without mutual interference with existing communication systems such as mobile communication, broadcasting, and satellite. The UWB modules 150 and 210 are mounted on the main terminal 100 and the auxiliary terminal 200 to measure an accurate distance between the two terminals and wirelessly (e.g., Bluetooth) transmit the measurement to the main terminal 100.

In addition, when the ball collides with the auxiliary terminal 200 serving as a hole cup by the user strokes the ball during golf practice (in the driving range or on the actual green) using an impact sensor 220 included in the auxiliary terminal 200, a measured value such as whether the ball has entered accurately or whether the ball is struck longer or less by several meters through the value measured by the impact sensor 220 may be transmitted to the main terminal 100. The main terminal 100 (e.g., the putting information calculator 130) may calculate the putting strength based on the impact sensor measurement value and output it to the output unit 140. This helps the user to accurately adjust the distance. For example, when describing a method of converting measurement data obtained by the impact sensor 220 of the auxiliary terminal 200 into a distance, at the moment the putt ball touches the auxiliary terminal 200, the impact numerical value (1-1000) measured by the impact sensor 220 may be converted into a distance (cm) through a normalized distance table and calculation formula.

In addition, by measuring the slope and height of the auxiliary terminal 200 using an (two-axis or more) acceleration sensor 230 built into the auxiliary terminal 200 and calculating in conjunction with the slope and height values measured in the main terminal 100, it is possible to correct the putting path. Through this, more accurate direction measurement is possible.

In the configuration shown in FIG. 13, the auxiliary terminal 200 acts passively. That is, the signals sensed by the impact sensor 220 and the acceleration sensor 230 are transmitted to the main terminal 100 through the UWB tag 210 without being self-processed by the auxiliary terminal 200. The main terminal 100 receives the sensed signal to process the sensed signal. However, unlike this, it is also possible to configure the auxiliary terminal to actively process the signal. The configuration of the auxiliary terminal 200′ in this case is shown in FIG. 14.

Referring to FIG. 14, a putting intensity calculator 240 for calculating the impact strength by processing the impact value sensed by an impact sensor 220 and further calculating the user's putting strength, a UWB distance measuring unit 250 for measuring the distance using the UWB tag 210 and the UWB anchor 150 of the main terminal 100 or correcting the distance calculated by the main terminal 100, and a slope calculator 260 for measuring and calculating the slope degree of a point where the auxiliary terminal 200 is located using an acceleration sensor 230 are installed in the auxiliary terminal 200.

In the case of the auxiliary terminal 200′ of FIG. 14, compared to the auxiliary terminal 200 of FIG. 13, the volume becomes larger and the cost increases. However, even without the main terminal 100, only the configuration included in the auxiliary terminal 200 may perform a basic user assistance operation.

The present invention described above can be implemented in terms of an apparatus or a method, in particular, the function or process of each component of the present invention may be implemented as a hardware element including at least one of a digital signal processor (DSP), a processor, a controller, an application-specific IC (ASIC), a programmable logic device (FPGA, etc.), and other electronic devices, and a combination thereof. In addition, it may be implemented as software in combination with a hardware element or independently, and the software may be stored in a recording medium.

Although the configuration of the present invention has been described in detail above through the preferred embodiment of the present invention, those of ordinary skill in the art to which the present invention pertains will understand that the present invention may be embodied in specific forms different from those disclosed in the present specification without changing the technical idea or essential features thereof. It should be understood that the embodiments described above are illustrative in all respects and not restrictive. The protection scope of the present invention is defined by the claims described below rather than the above detailed description, and all changes or modifications derived from the claims and their equivalent concepts should be construed as being included in the technical scope of the present invention.

1. A golf assisting device capable of measuring putting distance and putting direction and including a main terminal, the main terminal comprising:
a distance measuring unit configured to measure distance data from a user to a hole cup, the distance measuring unit including an input distance value processor for processing a distance value to the hole cup input by the user and outputting the distance data and an AR rangefinder for measuring distance by performing an augmented reality (AR) function;
a slope measuring unit configured to measure a slope degree value of the path from the user to the hole cup, the slope measuring unit including a slope sensor for measuring the slope degree value using an acceleration sensor of two or more axes and an AR slope meter for measuring the slope degree value in the AR method;
a putting information calculator configured to calculate the putting distance and the putting direction required for the user from the measured distance data and the slope degree value, the putting information calculator including a putting distance calculator for calculating the distance that the user should finally putt using the distance data and the slope degree value, a putting direction and deflection value calculator for calculating the left and right direction values and deflection values for final putting using the slope value, and a display information generator for generating and outputting display data for displaying the calculated putting distance and putting direction; and
an output unit configured to provide the putting information output from the display information generator of the putting information calculation unit to the user, the output unit including a putting distance numerical indicator for displaying the putting distance numerically, a putting direction numerical indicator for displaying the putting direction and the deflection value numerically, a putting direction/ball trajectory graphic indicator for graphically showing the putting direction and the ball trajectory by reflecting the putting direction numerical value displayed on the putting direction numerical indicator, and a putting direction graphic indicator for graphically displaying the actual putting direction from the user's location to the target hole based on the putting distance and putting direction data.

2. A golf assisting device capable of measuring putting distance and putting direction and including a main terminal, the main terminal comprising:
a distance measuring unit configured to measure distance data from a user to a hole cup, and including a data inputter for allowing the user to input a distance value to the hole cup and an input distance value processor for processing the input distance value and outputting the processed result as the distance data;
a slope measuring unit configured to measure a slope degree value of the path from the user to the hole cup, the slope measuring unit including a data inputter for allowing a user to input a slope value of a path up to the hole cup and an input slope value processor for processing the input slope value to output as a slope degree value;
a putting information calculator configured to calculate the putting distance and the putting direction required for the user from the measured distance data and the slope degree value, the putting information calculator including a putting distance calculator for calculating the distance that the user should finally putt using the distance data and the slope degree value, a putting direction and deflection value calculator for calculating the left and right direction values and deflection values for final putting using the slope value, and a display information generator for generating and outputting display data for displaying the calculated putting distance and putting direction; and
an output unit configured to provide the putting information output from the display information generator of the putting information calculation unit to the user, the output unit including a putting distance numerical indicator for displaying the putting distance numerically, a putting direction numerical indicator for displaying the putting direction and the deflection value numerically, a putting direction/ball trajectory graphic indicator for graphically showing the putting direction and the ball trajectory by reflecting the putting direction numerical value displayed on the putting direction numerical indicator, and a putting direction graphic indicator for graphically displaying the actual putting direction from the user's location to the target hole based on the putting distance and putting direction data.

3. The golf assisting device of claim 2, wherein the slope measuring unit further includes a slope sensor for measuring the slope degree value using a two-axis or more acceleration sensor in order to measure the slope degree value of the path from the user to the hole cup.

4. The golf assisting device of claim 2, wherein the distance measuring unit further performs a task of re-measuring the distance data measured by the distance measuring unit and correcting the re-measured distance as new distance data.

5. The golf assisting device of claim 2, wherein the slope measuring unit further performs a correction task of re-measuring the slope degree value measured by the slope measuring unit and correcting the re-measured slope degree value as a new slope degree value.

6. The golf assisting device of claim 2, further comprising:
an auxiliary terminal communicating with the main terminal,
wherein the main terminal is mobile communication carried by the user, and includes an ultra-wideband (UWB) anchor for communication with the auxiliary terminal, and
the auxiliary terminal is a round or stick-shaped terminal located at the hole cup point, communicates with the UWB anchor of the main terminal to exchange data with the main terminal, and includes a UWB tag for measuring the distance to the UWB anchor, an impact sensor for detecting the impact of the ball putt by the user, and an acceleration sensor for measuring the slope and height of the auxiliary terminal.

7. The golf assisting device of claim 6, wherein the auxiliary terminal further comprises a UWB distance measurement unit for measuring the distance using the UWB tag and the UWB anchor of the main terminal.

8. The golf assisting device of claim 6, wherein the auxiliary terminal further comprises a putting strength calculator for calculating the user's putting strength by processing the shock value detected by the shock sensor.

9. The golf assisting device of claim 2, wherein the auxiliary terminal further comprises a slope degree calculator for calculating by measuring the slope degree of the point where the auxiliary terminal is located using the acceleration sensor.

10. The golf assisting device of claim 1, wherein the distance measuring unit further performs a task of re-measuring the distance data measured by the distance measuring unit and correcting the re-measured distance as new distance data.

11. The golf assisting device of claim 1, wherein the slope measuring unit further performs a correction task of re-measuring the slope degree value measured by the slope measuring unit and correcting the re-measured slope degree value as a new slope degree value.

12. The golf assisting device of claim 1, further comprising:
an auxiliary terminal communicating with the main terminal,
wherein the main terminal is mobile communication carried by the user, and includes an ultra-wideband (UWB) anchor for communication with the auxiliary terminal, and
the auxiliary terminal is a round or stick-shaped terminal located at the hole cup point, communicates with the UWB anchor of the main terminal to exchange data with the main terminal, and includes a UWB tag for measuring the distance to the UWB anchor, an impact sensor for detecting the impact of the ball putt by the user, and an acceleration sensor for measuring the slope and height of the auxiliary terminal.

13. The golf assisting device of claim 12, wherein the auxiliary terminal further comprises a UWB distance measurement unit for measuring the distance using the UWB tag and the UWB anchor of the main terminal.

14. The golf assisting device of claim 12, wherein the auxiliary terminal further comprises a putting strength calculator for calculating the user's putting strength by processing the shock value detected by the shock sensor.
